(19) United States
(12) Patent Application Publication
(10) Pub. No.: US 2024/0278677 A1
(43) Pub. Date: Aug. 22, 2024

(54) ELECTRIC VEHICLE CHARGING SYSTEM WITH SMART CHARGING PLUG

(71) Applicant: EVJAM LLC, Minneapolis, MN (US)

(72) Inventors: Steven DICKE, Minneapolis, MN (US); Gregg KROMREY, Hudson, WI (US)

(73) Assignee: EVJAM LLC, Minneapolis, MN (US)

(21) Appl. No.: 18/582,327

(22) Filed: Feb. 20, 2024

Related U.S. Application Data
(60) Provisional application No. 63/446,913, filed on Feb. 20, 2023.

(51) Int. Cl. B60L 53/66; B60L 53/16; B60L 53/30; G06Q 50/06; H02J 7/00

(52) U.S. Cl. CPC B60L 53/665; B60L 53/16; B60L 53/305; G06Q 50/06; H02J 7/0042; B60L 2250/00

(57) ABSTRACT

An electric vehicle charging system with smart charging plug is disclosed. In one example, the present disclosure provides an electric vehicle charging system and method having a smart charging plug, and an electric vehicle smart charging plug. The electric vehicle smart charging plug includes a plug element, a plug status output, and a plug control system. The plug control system receives the plug status output and provides an output control signal to the plug element based on the plug status output. A plug control component provides the plug status output to the plug control system. In one example, the plug control component is located on the smart changing plug. The smart charging plug can provide a variety of functions, including plug detector, plug sensor, charging metering and payment system functions.

### CROSS REFERENCE TO RELATED APPLICATION

This Non-Provisional Patent application claims the benefit of the filing date of U.S. Provisional Patent Application Ser. No. 63/446,913, filed Feb. 20, 2023, which is herein incorporated by reference.

### TECHNICAL FIELD

The present disclosure relates generally to examples of electric vehicles and to devices for use with an electric vehicle, including electric vehicle batteries and electric vehicle charging systems and devices.

### BACKGROUND

Electric vehicles and electric vehicle devices provide quiet, clean, and efficient powertrains for moving from place to place or for getting work done.

For these and other reasons, there is a need for the present invention.

### SUMMARY

The present disclosure provides one or more examples of an electric vehicle and systems and/or devices for use with an electric vehicle. In one or more examples, the system is an electric vehicle charging system and/or charging device.

In one or more examples, the present disclosure provides an electric vehicle charging system having a smart charging plug, and an electric vehicle smart charging plug. In one example, the electric vehicle smart charging plug includes a plug element, a plug status output, and a plug control system. The plug control system receives the plug status output and provides an output control signal to the plug element based on the plug status output. A plug control component provides the plug status output to the plug control system. In one example, the plug control component is located on the smart changing plug.

The smart charging plug can provide a variety of functions, including plug detector, plug sensor, charging metering and payment system functions.

Additional and/or alternative features and aspects of examples of the present technology will become apparent from the following description and the accompanying drawings.

### BRIEF DESCRIPTION OF THE DRAWINGS

The Figures generally illustrate one or more examples of an electric vehicle and/or devices for use with an electric vehicle such as electric vehicle batteries or electric vehicle charging systems and devices, including an electric vehicle smart charging plug.

FIG. 1 is a diagram generally illustrating an electric vehicle charging system including a smart charging plug, according to examples of the present disclosure.

FIG. 2 is a diagram illustrating an electric vehicle charging system including a smart charging plug, according to examples of the present disclosure.

FIG. 3 is a diagram generally illustrating a smart charging plug, according to examples of the present disclosure.

FIG. 4 is a diagram illustrating a smart charging plug, according to examples of the present disclosure.

FIG. 5 is a block diagram illustrating electric vehicle smart charging plug systems, according to examples of the present disclosure.

FIG. 6 is a block diagram illustrating an electric vehicle smart charging plug, according to examples of the present disclosure.

FIG. 7 is a block diagram illustrating an electric vehicle smart charging plug including a smart charging plug control system, according to examples of the present disclosure.

FIG. 8 is a diagram illustrating an electric vehicle charging system including a smart charging plug, according to examples of the present disclosure.

FIG. 9 is a diagram illustrating an electric vehicle charging system smart charging plug, according to examples of the present disclosure.

FIG. 10 is a diagram illustrating an electric vehicle charging system smart charging plug, according to examples of the present disclosure.

FIG. 11 is a flow diagram illustrating a method of charging an electric vehicle using a smart charging plug, according to examples of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

Electric vehicles (EVs), such as automobiles (e.g., cars and trucks), autonomous vehicles, watercraft, all-terrain vehicles (ATVs), side-by-side vehicles (SSVs), and electric bikes, for example, offer a quiet, clean, and more environmentally friendly option to gas-powered vehicles. Electric vehicles have electric powertrains which typically include a battery system, one or more electrical motors, each with a corresponding electronic power inverter (sometimes referred to as a motor controller), and various auxiliary systems (e.g., cooling systems). Electric vehicle charging systems are utilized for charging the electric vehicle battery system.

Electric Vehicle Charging System with Smart Charging Plug

The present disclosure provides an EV charging system with a smart charging plug. The smart charging plug is capable of receiving a sensed plug status output, and providing an output control signal based on the input. For example, the smart plug may include a temperature sensor, light sensor, or motion sensor. Based on a sensed signal, the smart plug can turn on a plug heater, plug light, or follow a predetermined protocol based on the sensed input.

In one example, the smart plug includes a plug control system (e.g., a smart board or microprocessor based control system) that can include an on-board controller and battery. The smart charging plug can communicate with an electric vehicle, electric vehicle charging station, charging facility master control system or a user control application (e.g., via a phone). The smart plug can receive one or more control status outputs and provide control outputs based on the control inputs. In one or more examples, the smart plug can perform any function performed by a conventional electric vehicle charging station.

The EV charging system including a smart charging plug may be employed in any suitable parking facility, such as parking ramps and surface parking lots, for example, and may be employed both as part of newly constructed parking facilities or adapted for use in existing parking facilities. The parking facility may be most any type of parking facility, such as a public parking facility (e.g., shopping centers), a corporate parking facility (e.g., associated with a business, such as manufacturing facility or a hotel), and a commercial parking facility (e.g., a pay facility)—any type of parking facility where EVs will be parked for extended time periods (e.g., for a half hour or more) while the drivers are occupied with other tasks (e.g., shopping, dining, attending a sporting event, working, etc.). In examples, the parking facility may include parking for both EVs and non-electric vehicles.

One or more examples and features of the charging system are detailed herein and illustrated in the Figures.

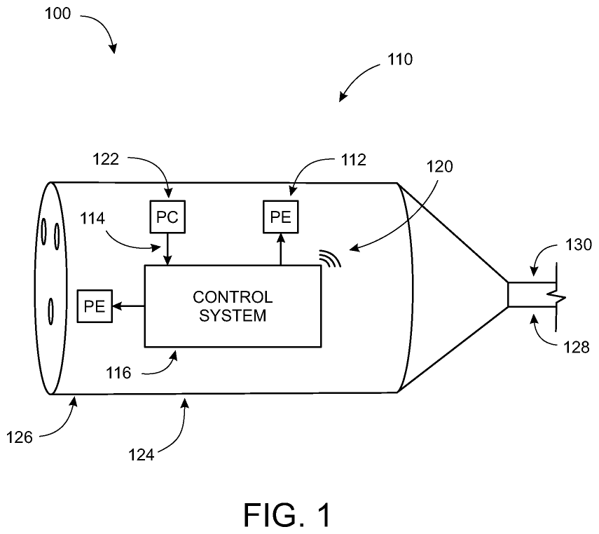

FIG. 1 is a diagram generally illustrating an electric vehicle charging system 100 including a smart charging plug 110, according to examples of the present disclosure. The smart charging plug 110 includes a plug element 112, a plug status output 114, and a plug control system 116. The plug control system 116 receives the plug status output 114 and provides an output control signal 118 to the plug element 112 based on the plug status output 114.

In one example, a communication link 120 is provided between the plug control system 116 and a remote control system. The communication link 120 can be a wireless communication link (e.g., bluetooth, wifi, BLE, etc.). The remote control system can be a charging station and/or an electric vehicle control system or user interface/control application.

The smart charging plug 110 includes a plug control component 122. The plug control component 122 provides the plug status output 114 to the plug control system 116. In one example, the plug control component 112 is located on the smart charging plug 110.

In one example, the smart charging plug includes a plug body 124. The plug control component 122 includes a temperature sensor that provides the plug status output 114 to the plug control system 116 based on a sensed temperature. The plug element 112 includes a plug heater located on the plug body 124 that is controlled by the plug control system 116. The plug heater includes a heating element integrated into the smart charging plug 110. In one example, the heating element includes a spiral heating coil integrated into the plug body 124. In one example, the heating element operates to heat the plug body 124 only at a plug location of the sensed temperature (e.g., such as an end of the plug body 124 that plugs into an electric vehicle charging port).

In one example, the plug body 124 includes a first end 126 and a second end 128. The first end 126 is configured to couple to an electric vehicle charging port. The second end 128 is coupled to a charging cable 130. The plug element 112 and the control component 122 are located on the plug body 124. For example, the plug first end 126 can be configured for Level 1, Level 2, Level 3 DC fast charging, a combined CCS charging system or other charging system configuration. Additionally, the plug control system 116 can also be located on the plug body 124. Communication link 120 can be provided between the plug control system 116 and a remote control system. The communication link 120 can be a wireless communication link. The remote control system can be a charging station, an electric vehicle control unit, and/or a user application (e.g., on a tablet, computer, or phone).

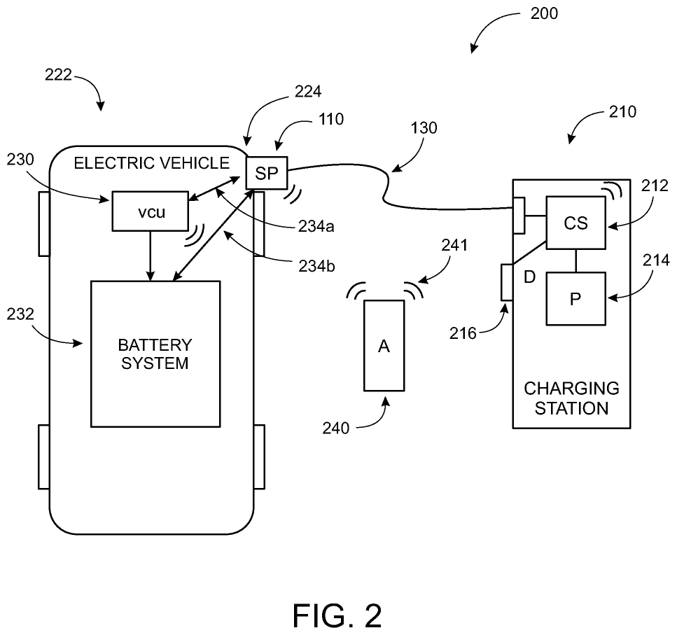

FIG. 2 is a diagram illustrating an electric vehicle charging system 200 including a smart charging plug 110, according to examples of the present disclosure. The smart charging system 200 includes a charging station 210. The smart charging plug 110 is tethered to charging station 210 via charging cable 130.

Charging station 210 includes a control system 212. Charging power 214 is fed through control station 210, and controlled via control system 212. Charging station 210 includes a charging plug dock 216. When not in a charging position, the smart charging plug 110 is stored at charging station 210 charging dock 216. Charging dock 216 is in communication with smart charging plug 110 and charging station control system 212. When the smart charging plug 110 is located in charging plug dock 216 it is communicated to control system 212. Control system 212 can operate to lock smart charging plug 110 into the charging plug dock 216 when not in use.

As illustrated, smart charging plug 110 is in a charging position, being plugged into electric vehicle 222 at charging port 224. Electric vehicle 222 includes a vehicle control unit 230 in communication with battery system 232. The vehicle control unit 230 is in communication with smart charging plug 110, indicated at 234a, 234b for controlling charging of battery system 232.

Application 240 is illustrated in communication with smart charging plug 110, control system 212, vehicle control unit 230. The communication link 241 can be a wired or wireless communication link. Application 240 can be a user interface application. For example, application 240 can be a smart phone, tablet, graphical user interface, EV graphical user interface, charging station user interface, smart charging plug user interface, or other interface.

In operation, smart charging plug 110 communicates with charging station 220, electric vehicle 222, and application 240 to perform a charging operation. In one example, the smart charging plug is configured to perform any user control operation typical of a conventional charging station, such as charging system activation, metering, authorization, and billing. Additionally, smart charging plug 110 is configured to perform smart plug functions that enhance smart charging plug operation.

In one example, it is not necessary for charging station 210 to have its own control system 212. The charging system 200 is entirely controlled by smart plug 110, including coordination with application 240 and electric vehicle 222 (e.g., via vehicle control unit 230).

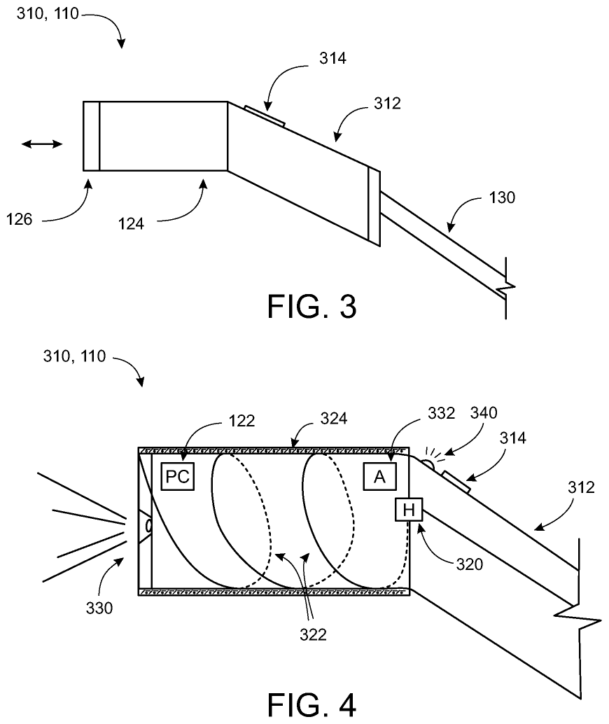

FIG. 3 is a diagram generally illustrating a smart charging plug 310, according to examples of the present disclosure. The smart charging plug 310 is similar to the smart charging plug 110 previously described herein. The smart charging plug 310 includes plug body 124 and plug handle 312. The plug handle 312 provides an area for a user to grip the smart charging plug 310. Charging cable 130 is routed through the plug handle 312.

Plug handle 312 includes a switch 314. Switch 314 is coupled to the plug handle 312 and is operable by a user. In one or more examples, switch 314 is operably coupled to smart charging plug 310 to aid in one or more operations of devices local to smart charging plug 310. For example, the switch 314 can be used to turn on a charging plug light, turn on a charging plug heating element, or other local charging plug operation.

FIG. 4 is a diagram illustrating smart charging plug 110, according to examples of the present disclosure. The smart charging plug 110 includes a plug element that is a plug heater 320. The smart charging plug includes control component 122 that includes a temperature sensor. Based on a sensed temperature, the plug control system 116 controls operation of the plug heater 320.

In one example, the plug heater 320 is a resistive heater and includes a resistive heating element. In one example, the resistive heating element is in the form of a coiled heating wire 322 that is coiled about an outer periphery of the plug body 124. The heating coil 322 is located near an outer surface of the plug body 124. Alternatively, the heating element can be an induction heater, or other type heater configuration. In one example, the plug body 124 includes an outer heating layer 324. The outer heating layer 324 can include a thin metallic layer, one or more metal pieces, or can be loaded with metal material/fiber pieces or other material/fiber to aid in heating the plug body. Once the heating coil 322 is activated, the outer heating layer 324 is warmed up and retains heat due to the heat retaining material located within the heating layer 324. In other embodiments, the outer heating layer 324 includes one or more other materials that aid in retaining heat within the outer heating layer 324.

In one example, the plug body includes multiple temperature sensors associated with different areas of the plug body. The control system operates to activate the heating element only in areas where the sensed temperature falls below predefined limits. In another example, the heating element is only located at first end 126 where the smart charging plug 110 comes in contact with an electric vehicle charging port. In another example, the plug heater provides heat to the plug body 124 only in an area near where the plug contacts the electric vehicle charging port or the charging station charging plug dock. The smart charging plug 110 heater 320 can be temperature activated for use in harsh weather conditions to avoid operational issues associated with freezing rain and snow issues.

It is recognized that activation of the smart charging plug 110 plug heater 320 is not limited to sensing of a predefined temperature at the smart charging plug 110 location. For example, the plug heater can be temperature activated, motion activated, and/or location activated.

The smart charging plug 110 can require multiple conditions be met before activating heating of the smart charging plug. For example, the smart charging plug 110 can require two conditions be met before activating the charging plug 110 plug heater 320. Example conditions include sensing of a set temperature and sensing of the presence of moisture (e.g., rain or snow). Multiple sensed conditions can include, for example, sensing of a set temperature and location of plug in an EV charging port; sensing a set temperature and sensing removal of the plug from a charging station dock; and/or sensing a predefined plug temperature and sensing movement of the plug or removal of the plug from the charging station dock.

Alternatively, a temperature sensor and/or moisture sensor is not required to be located on the smart charging plug. Smart charging plug area temperature and moisture can be communicated to the plug control system from a remote location (e.g., using artificial intelligence or via the internet) via a communication link and used to determine activation of the charging plug heater 320 or other plug elements 112.

The smart charging plug 110 can further include a plug light 330. In one example, the plug light 330 is located at the first end 126 of the plug body 124. The plug light 330 can be useful in multiple situations, including when connecting the smart charging plug 110 to an EV charging port at night. The plug light 330 can be manually switched on or off via plug switch 314. The plug light could be automatically switched on if certain predefined conditions are met. For example, the plug light 330 can be switched on if it is a nighttime or low light condition (e.g, sensed via a light sensor or received via a remote communication link), and plug movement is detected (e.g., via motion detector 332 such as an accelerometer) or if the smart charging plug 110 is removed from the charging plug dock 216 at the charging station.

Smart charging plug 110 can include other plug elements 112 such as a plug notification element 340. In one example, the plug notification element 340 is a visual indicator that is activated or “lights up” during an electric vehicle charging operation. The active charging light can be a plug indicator light. For example, the active charging light can change color during a charging operation when the plug is active. The active charging light can also convey a charging level. The active charging light can change from yellow to green based on the charging level of the EV battery pack. Can be a single light or band of lights that change color or intensity as the EV battery is charged. The active charging light can include a series of lights in the form of a light spectrum, dots or LED's. Each light can be lit up based on the EV battery pack charging level.

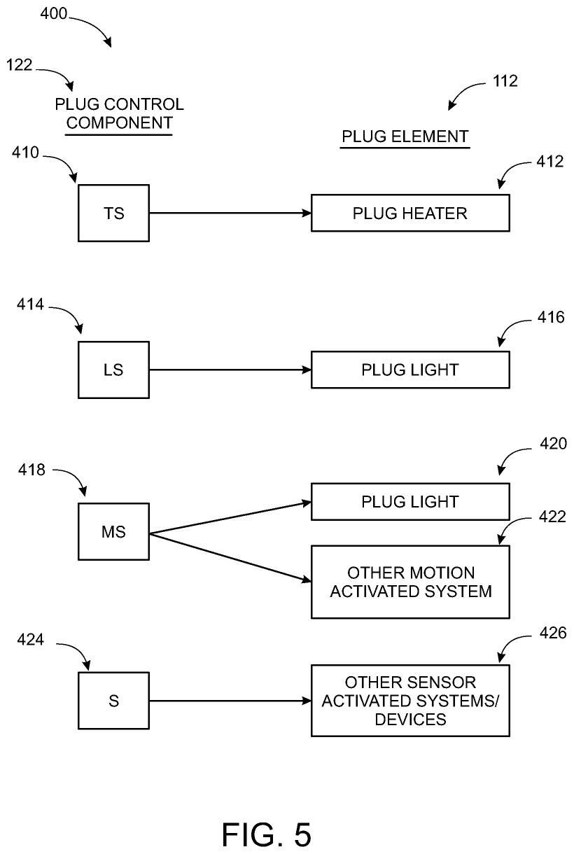

FIG. 5 is a block diagram illustrating an electric vehicle smart charging plug system at 400, according to examples of the present disclosure. The block diagram 400 illustrates a relationship between example plug control components 122 and corresponding charging plug elements 112.

Temperature sensor 410 can be located on the smart charging plug or remote from the smart charging plug. A plug heater 412 is located on the smart charging plug. Based on a sensed temperature, plug heater 412 can be selectively activated. The temperature sensor 410 can be directly linked to the plug heater 412, or they can be linked (i.e., communicate) through the plug control system.

Light sensor 414 can be located on the smart charging plug or remote from the smart charging plug. A plug light 416 is located on the smart charging plug. Based on a sensed light level, plug light 416 can be selectively activated. The light sensor 414 can be directly linked to the plug light 412, or they can be linked (i.e., communicate) through the plug control system.

Motion sensor 418 can be located on the smart charging plug or remote from the smart charging plug. A plug light 420 or other motion activated system is located on the smart charging plug. Based on a sensed motion by motion sensor 418, plug light for 420 or other motion activated system 422 can be selectively activated. The motion sensor 418 can be directly linked to the plug light 420 or other motion activated system 422 (e.g., a plug heater), or they can be linked (i.e., communicate) through the plug control system.

In a similar manner, other sensors 424 can be located on the smart charging plug or remote from the smart charging plug. Other sensor activated systems and/or devices are located on the smart charging plug. Based on a sensed component by sensor 424, other sensor activated systems 426 can be selectively activated. The sensor 424 can be directly linked to the other sensor activated systems or devices 426 or they can be linked (e.g., communicate) via the plug control system.

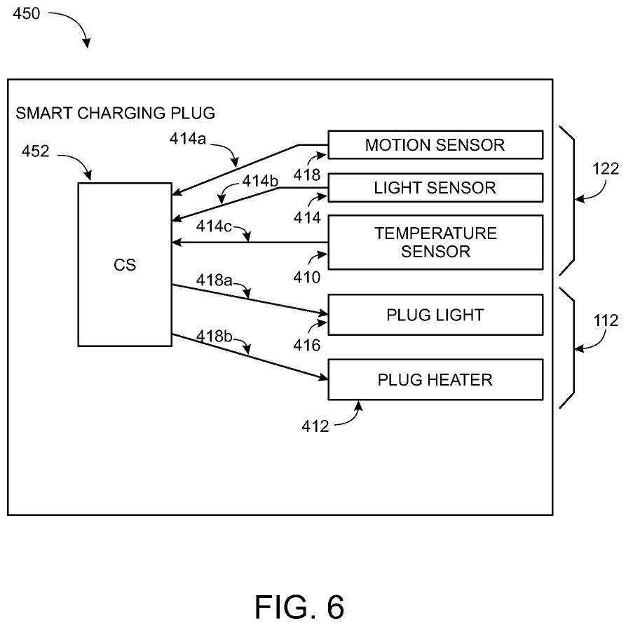

FIG. 6 is a block diagram illustrating an electric vehicle smart charging plug at 450, according to examples of the present disclosure. Smart charging plug 450 can be similar to the smart charging plugs previously described herein. Smart charging plug 450 includes control system 452. In this example, the control system 452 is located on the smart charging plug 450. Temperature sensor 410, light sensor 414 and motion sensor 418 are located on smart charging plug 450. Each of the sensors 410, 414 and 418 provide corresponding plug status outputs 414a, 414b, 414c to control system 452 representative of a sensed plug status. In response, control system 452 provides a plug output control signal 418a, 418b to plug light 416 and/or plug heater 412 based on one or more sensed criterias as previously described herein.

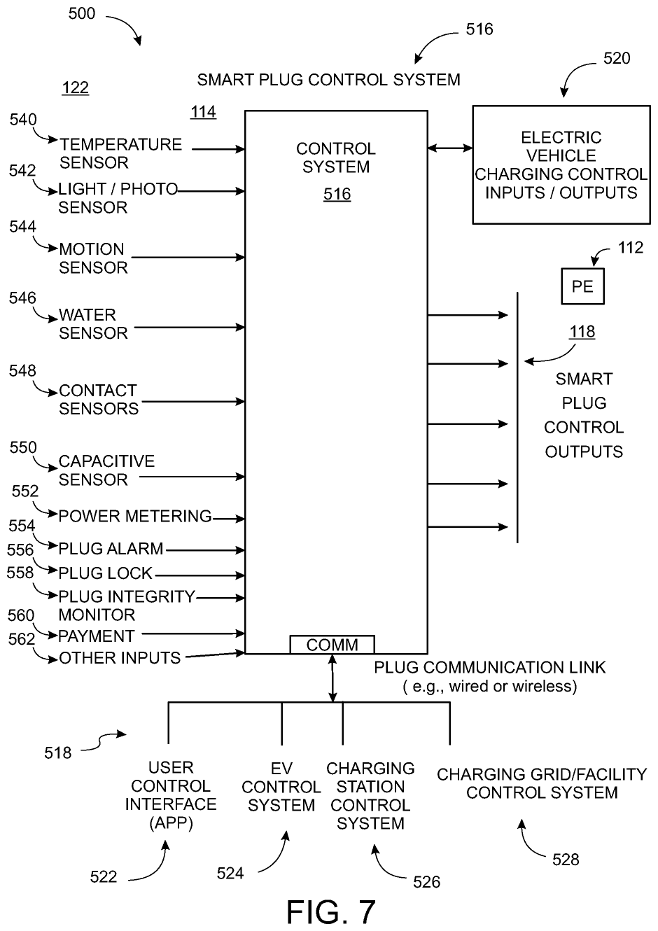

FIG. 7 is a block diagram illustrating an electric vehicle charging system including a smart charging plug 500, according to examples of the present disclosure. The smart charging plug 500 includes smart plug control system 516. The smart charging plug 500 including smart plug control system 516 is similar to the smart charging plugs previously described herein.

Smart charging plug 500 includes multiple plug control components 122 (e.g., plug sensors and detectors) located on the smart charging plug 500. The plug control components 122 provide their respective plug status outputs 114 to the plug control system 516. In response, the smart plug control system 516 provides output control signals 118 to corresponding plug elements 112 (e.g., plug heater, plug user interface, plug metering, etc.). Control system 516 also communicates with an electric vehicle control unit prior to and during a charging operation, indicated at 520. The smart plug control system is in communication with other remote control systems. In one or more examples, the smart plug control system is in communication with user control interface 522, EV control system 524, charging station control system 526 and/or charging grid/facility control system 528.

The smart charging plug 500 can include one or more of the following plug control components 122 located on the smart charging plug. The control components 122 provide corresponding plug status outputs 114 to the smart plug control system 516. Example plug control components 122 are as follows:

Plug temperature sensor. Plug temperature sensor 540 can be located on the surface of the smart charging plug 500 or located integral to the plug body. The plug temperature sensor 540 provides a temperature status signal to the smart plug control system 516. In one example, the temperature status signal is used to determine whether to activate a plug heater.

Plug light/photo sensor. Plug light sensor 542 provides a light status signal to smart plug control system 516. In one example, the plug light sensor status signal aids in determining whether to activate a plug light.

Plug motion sensor. Plug motion sensor 544 provides a motion status signal to smart plug control system 516. In one example, the plug motion sensor includes an accelerometer. In one example, the plug motion status signal is used to determine whether to activate a plug light.

Plug water/moisture sensor. Plug water/moisture sensor 546 provides a moisture status signal to smart plug control system 516. The plug moisture status signal can provide a moisture alarm signal to the smart plug control system 516.

Plug contact sensor. Plug contact sensor 548 provides a contact status signal to smart plug control system 516. For example, the contact status signal can be used to determine if the smart charging plug is in contact with an EV charging port and is in a charging position, or whether the smart plug is docked at a charging station.

Plug capacitive sensor. Plug capacitive sensor 550 provides a status signal to smart plug control system 516. The capacitive status signal can be used to determine if a user is holding on to the smart plug handle or other smart plug status that uses the capacitive sensor.

Plug power metering. Plug power metering 552 provides metering signals to smart plug control system 516. For example, the metering signals can aid in determining charging power levels, charging status, and charging capacity. On plug power metering can perform any metering function conventionally performed at a charging station.

Plug authorization/alarm. Plug alarm sensor 554 provides alarm signals to smart plug control system 516. For example, the plug alarm signals can be used by the smart plug control system to determine whether an alarm situation exists, and whether to prematurely terminate/deactivate a charging operation being formed on an electric vehicle.

Plug lock/authorization. Plug authorization sensor 556 provides plug authorization status signals to smart plug control system 516. The plug authorization status signals can be used by the smart plug control system 516 to determine whether to lock or unlock the smart charging plug for use in a charging operation.

Plug integrity monitor. Plug integrity monitor 558 provides a plug integrity status signal to the smart plug control system 516.

Plug charging payment processor. Plug charging payment processor 560 can provide payment status signals to smart plug control system 516. The payment status signals can be used to aid in processing payment for a charging operation (e.g., via a credit card or phone).

Other plug inputs. Other plug inputs 562 provide other status signals to the smart plug control system 516.

The smart plug control system 516 can provide control outputs 118 to one or more of the following plug elements 112 and can provide one or more of the following smart plug control components 122.

Plug heater. Plug with heated plug design. Includes a plug heater having a number of suitable configurations. For example, the plug heater can be a resistive heater and include a resistive heating element, can be an induction heater, or other type heater. Metal piece or the outer plug material can be loaded with metal material/fibers to aid in heating the plug body. In one example, the plug heater can be in the form of a heating coil located near the surface of the plug. In one example, the plug heater provides heat to the plug body only in an area near where the plug contacts the electric vehicle charging station dock or the electric vehicle port. Can be temperature activated for use in harsh weather conditions to avoid freezing rain and snow issues. Can be activated-once plugged into the charging station holder or when plugged into the vehicle. Can be sensor activation, such as temperature activated, motion activated, or location activated (e.g., act ev charging port or charging station dock).

Plug light. Plug could include a light for night charging or as an aid in lining up the plug with the ev plug location. Can be motion activated, night time activated, or become active when removed from the charging station dock or when removed from ev charging port.

Active Charging Light. Charging indicator light. Plug could change color when charging, active or hot. Light could also convey charging level. Could include series or spectrum of dots, led's etc. Each one lights up based on EV battery charging level. Also could be a single light or band of light that changes color or intensity as the battery is charged.

Smart board. Plug could include a smart board that includes a controller and communication link (e.g., wired or wireless). Can communicate with the charging station control system.

Smart sensor system. Plug can include one or more smart sensors.

Motion sensor. In one example, the smart sensor system includes a motion sensor (e.g., an accelerometer or other motion sensor).

Light sensor. In another example, the smart sensor system includes a photo sensor for indicating darkness.

Temperature sensor. In another example, the smart sensor includes a temperature sensor. For example, the temperature sensor is activated when the temperature drops below freezing. Temperature sensor could be activated when the temperature is too hot. Plug temperature sensor could indicate a hot plug, etc due to breakdown of the plug insulation, plug malfunction, crack in plug body etc.

Water/moisture Sensor. A water sensor could be located in the plug to alert to clean/dry plug of water prior to plugging it in, or to alert a user of other possible water/moisture issues.

Contact sensor. Plug could include one or more contact sensors for when plugged into a charging station dock or when plugged into an ev charging port. Multiple control lines are typically located in a plug.

Capacitive Sensor. For example, could have a capacitive sensor that senses when a plug is grasped by a user for conducting a charging operation.

Metering. Plug can include one or more components of a metering (e.g. power transfer metering) system that coordinates with the smart plug control system, charging station control system, electric vehicle control system and/or a charging system network, facility, or charging grid. For example, the smart charging plug can meter power statistics associated with power transferred to an electric vehicle when charging the battery.

Other control devices. Face recognition, keypad, fingerprint sensor, etc. Could be used as a safety device such as preventing children from playing with it Could also be located on the charging station itself.

Plug docking contact. A control device located on the plug that alerts a user if the plug is not timely returned to the plug docking station. Could interact with the docking station itself.

Plug Alarm. One or more plug alarms such as charging complete/remove plug from charging port alarm. For example, could be visual, sound, or app alarm. Could also be used as an unauthorized user alarm, etc.

Plug Lock. The charging plug can include a plug lock for activation of use of the charging plug or use of the charging station. The plug lock can be configured to allow authorized use only. For home use, this could be used as part of a “child lock” system. The plug lock can take on a number of forms, such as including a combination lock set to activate the plug (done either mechanically or via software/display PIN). In one example, the plug lock is in the form of a fingerprint reader/sensor that can be tied to one or more users, for giving user access to the charging plug or charging system. In another example, the charging lock (e.g., fingerprint reader), is located on or near the charging station or includes a PIN entry at or near the charging station or on a phone app.

General. Plug could take on any power and control items that are normally done in a charging station. Charging station could be a “dummy” structure. All charging and charging control could actually be controlled via the smart plug (without user knowledge).

Plug Integrity Monitor. Monitors the integrity of a plug. For example, it could be a crack sensing resistor. Resistor could also serve as a plug heater. Could also be a plug layer that acts as part of a sensor circuit.

Plug Display. Plug could have a display. The display could be integral the plug body. Plug display output only may include touchscreen for entering data.

Payment Device/Sensor. Plug could include a payment sensor such as a credit card payment sensor including provisions for wireless payment. Could be contactless payment enabled such as configured to use a chip card or payment-enabled device (e.g., a cell phone wallet or smart watch).

Plug payment system. The smart charging plus can include a charging payment processing system such as a credit card reader.

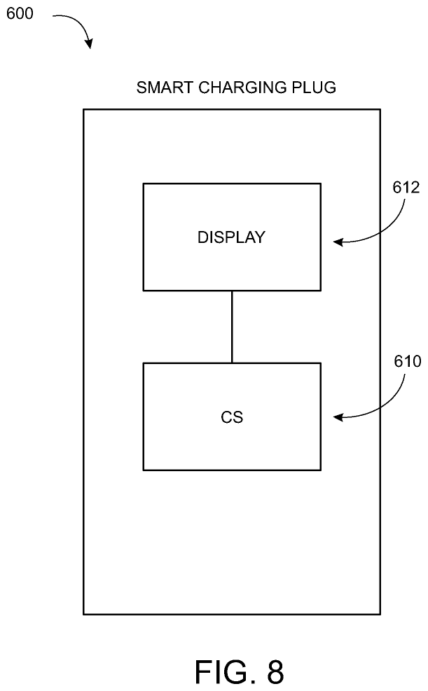

FIG. 8 is a diagram illustrating an electric vehicle charging system including a smart charging plug 600, according to examples of the present disclosure. The smart charging plug 600 is similar to the smart charging plugs previously described herein, and can include a smart charging plug control system 610 in communication with a smart charging plug user interface 612 (i.e., a display). In one example, the display 612 is a touch screen display. The smart charging plug user interface 612 is located on the smart charging plug.

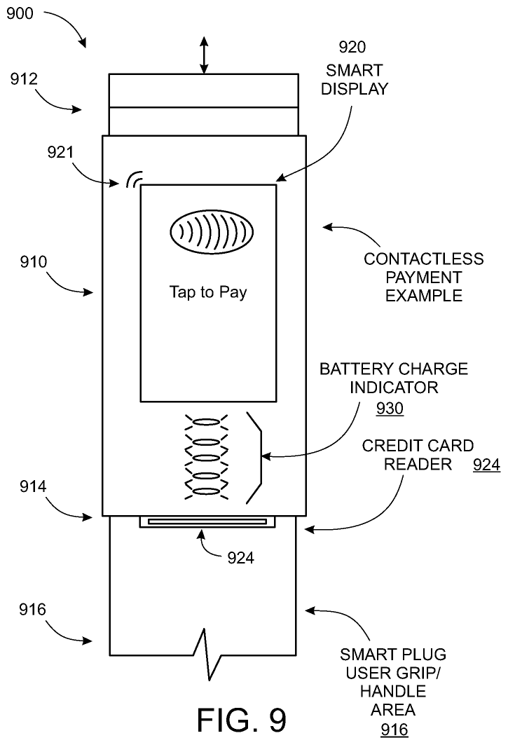

FIG. 9 is a diagram illustrating an electric vehicle charging system smart charging plug 900, according to examples of the present disclosure. One example of a block diagram of smart charging plug 900 is illustrated in FIG. 7.

Smart charging plug 900 includes a plug body 910, a first end 912, and a second end 914. The first end 912 plugs into or couples to an electric vehicle charging port. A plug handle 916 is located at the second end 914.

A plug smart display 920 (e.g., a user interface) is located on the plug body 910. In one example, the smart display 920 displays charging options, charging status, payment options, and payment status. Further, the smart display 920 can be used to accept payment (e.g., smart chip payment via communication oink 921) as illustrated. The smart charging plug 900 can include a credit card reader 924. The card reader 924 can be located on the plug body 910 or on the plug handle 916. The smart charging plug can include other status indicators, such as the battery charge indicator 930 illustrated.

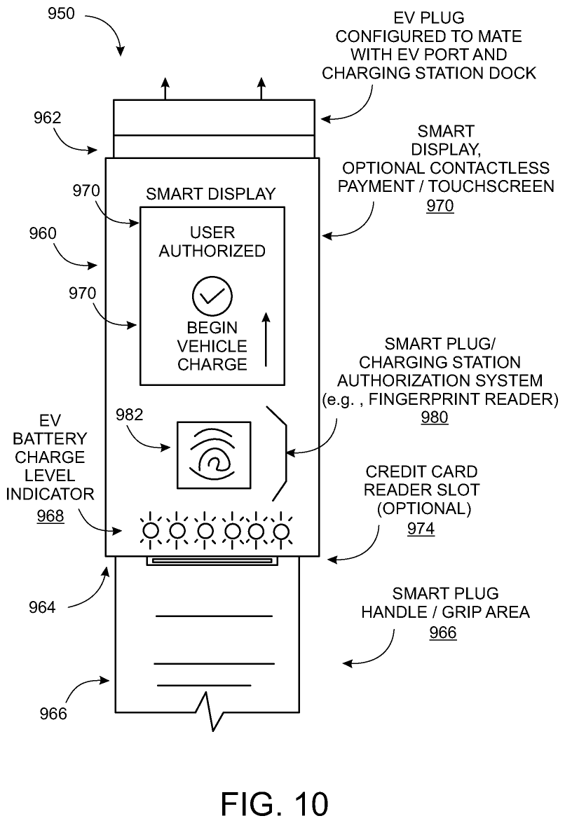

FIG. 10 is a diagram illustrating an electric vehicle charging system smart charging plug 950, according to examples of the present disclosure. One example of a block diagram of smart charging plug 950 is illustrated in FIG. 7.

Smart charging plug 950 includes a plug body 960, a first end 962, and a second end 964. The first end 962 plugs into or couples to an electric vehicle charging port. A plug handle 966 is located at the second end 964.

A plug smart display 970 (e.g., a user interface) is located on the plug body 960. In one example, the smart display 970 displays charging options, charging status, payment options, payment status, and/or user authorization. The smart display 970 can be used to accept payment (e.g., smart chip payment). The smart charging plug 970 can include a credit card reader 974. The card reader 974 can be located on the plug body 960 or on the plug handle 966. The smart charging plug can include other status indicators, such as the battery charge indicator 968 illustrated.

The smart charging plug 950 can also include a user authorization system 980. The user authorization system can be multiple forms, such as the fingerprint reader 982 illustrated. The status of user access can be displayed on smart display 970.

The charging system including a smart charging plug disclosed herein can include the control systems of a conventional charging station, eliminating the need for expensive charging stations.

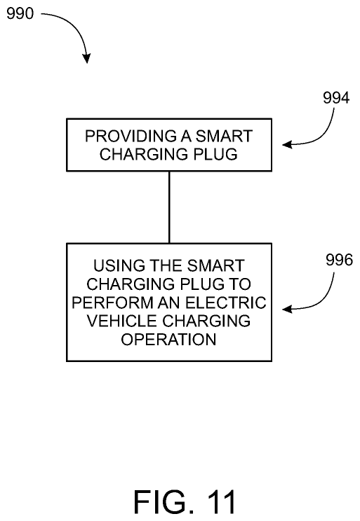

FIG. 11 is a flow diagram illustrating at 990 a method of charging an electric vehicle using a smart charging plug, according to examples of the present disclosure. At 994, a smart charging system including a smart charging plug is provided. The smart charging plug is detailed herein and includes one or more charging components and elements as described herein. At 996, the smart charging plug is used to perform an electric vehicle charging operation. In one or more examples, the smart charging plug has the functionality of a conventional charging station.

It is recognized that the charging system of the present disclosure can be configured for use in many charging system applications, including those not disclosed herein.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

The claims are part of the specification.

1. An electric vehicle smart charging plug comprising:
a plug element located on the charging plug;
a plug status output; and
a plug control system that receives the plug status output and provides an output control signal to the plug element based on the plug status output.

2. The smart charging plug of claim 1, comprising:
a communication link between the plug control system and a remote control system.

3. The smart charging plug of claim 2, where the communication link is a wireless communication link.

4. The smart charging plug of claim 2, where the remote control system is a charging station.

5. The smart charging plug of claim 2, where the remote charging system is a user control application.

6. The smart charging plug of claim 1, comprising:
a plug control component that provides the plug status output to the plug control system.

7. The smart charging plug of claim 6, where the plug control component is located on the smart changing plug.

8. The smart charging plug of claim 6, comprising:
a plug body;
a plug control component comprising a temperature sensor associated with the plug body that provides the plug status output to the plug control system based on a sensed temperature; and
a plug heater located on the plug that is controlled by the plug control system.

9. The smart charging plug of claim 8, the plug heater comprising a heating element integrated into the smart charging plug.

10. The smart charging plug of claim 8, the heating element comprising a spiral heating coil integrated into the plug body.

11. The smart charging plug of claim 9, where the heating element operates to heat the plug only at a plug location of the sensed temperature.

12. An electric vehicle smart charging plug comprising:
a plug body having a first end and a second end, where the first end is configured to couple to an electric vehicle charging port and the second end is coupled to a charging cable;
a plug element;
a plug control system;
a first plug control component that senses a first plug status, and provides a first plug status output based on the first plug status;
a second plug control component that senses a second plug status, and provides a second plug status output based on the second plug status;
where the plug control system receives the first plug status output and the second plug status output, and provides an output control signal to the plug element based on the first plug status output and the second plug status output.

13. The smart charging plug of claim 12, where the plug element and the first plug control component are located on or in the plug body.

14. The smart charging plug of claim 13, where the plug control system is located in the plug body.

15. The smart charging plug of claim 12, comprising:
a communication link between the plug control system and a remote control system, where the communication link is a wireless communication link.

16. The smart charging plug of claim 15, where the remote control system is at least one of a charging station and a user control application.

17. An electric vehicle charging system comprising:
a charging plug comprising a plug body having a first end and a second end, where the first end is configured to electrically couple to an electric vehicle charging port and the second end is coupled to a charging cable, a plug element, a plug control system, and a plug control component that senses a plug status, and provides a plug status output based on the plug status;
where the plug control system receives the plug status output and provides an output control signal to the plug element based on the plug status output;
where the plug control system is configured to be in communication with an electric vehicle control unit; and
a charging station in communication with the plug control system, where the charging station is electrically coupled to the charging cable.

18. The charging system of claim 17, comprising:
a plug metering system located in the plug body in communication with the plug control system.

19. The charging system of claim 18, comprising:
a charging plug payment system coupled to the plug body and in communication with the plug control system.

20. The charging system of claim 18, comprising:
a graphical user interface located on the plug body, in communication with the plug control system; and
a user authorization system located on the plug body and in communication with the plug control system.
